(19) United States
(12) Patent Application Publication
(10) Pub. No.: US 2026/0162134 A1
(43) Pub. Date: Jun. 11, 2026

(54) METHODS AND SYSTEMS FOR DETERMINING ATTRITION AT A MERCHANT

(71) Applicant: MASTERCARD INTERNATIONAL INCORPORATED, Purchase, NY (US)

(72) Inventors: Pankaj YADAV, Faridabad (IN); Sonia GUPTA, Gurgaon (IN); Siddhartha ASTHANA, New Delhi (IN)

(73) Assignee: MASTERCARD INTERNATIONAL INCORPORATED, Purchase, NY (US)

(21) Appl. No.: 18/974,084

(22) Filed: Dec. 9, 2024

(51) Int. Cl. G06Q 30/0202

(52) U.S. Cl. CPC G06Q 30/0202

(57) ABSTRACT

Methods and systems for determining attrition at a merchant are disclosed. The method performed by the server system includes accessing information related to a subset of cardholders from a database. The method includes generating a set of features for each cardholder in the subset of cardholders based, at least in part, on transaction attributes associated with each transaction performed by each cardholder. The method includes generating an opt-out feature for each cardholder based on a historical transaction dataset. Herein, the opt-out feature indicates whether an individual cardholder has requested to cancel ongoing recurrent payments with the merchant. The method also includes generating, by a Machine Learning model, an attrition score for each cardholder based, at least in part, on the corresponding set of features, and the corresponding opt-out feature of each cardholder. The attrition score indicates a probability of each cardholder refraining from engaging in future transactions with the merchant.

### TECHNICAL FIELD

The present disclosure relates to artificial intelligence-based processing systems and, more particularly, to electronic methods and complex processing systems for determining attrition at a merchant.

### BACKGROUND

‘Attrition’ refers to a gradual reduction in the number of cardholders engaging with a merchant over time. The attrition occurs due to several reasons such as the cardholders stopping using a particular card, closing associated bank accounts, or switching to competing merchants. This may be due to dissatisfaction with the goods or services provided by the merchant, better offers from competing merchants, changes in the needs of the cardholders, etc., among other reasons. Attrition is a crucial metric for merchants to evaluate their business performance, as it directly affects revenue, cardholder retention strategies, and long-term growth. Monitoring and understanding attrition help the merchants to remain competitive and adjust their business strategies accordingly to minimize losses.

A high attrition signals cardholder dissatisfaction, tending the merchants to improve service, introduce competitive offerings, or implement loyalty programs. By identifying the drivers behind the attrition, the merchants can take proactive measures to retain the cardholders, reducing the costs associated with engaging with new ones. Additionally, a lower attrition signals a higher cardholder lifetime value, increased revenue, and greater cardholder satisfaction, making it a critical aspect of business strategy.

There are several conventional methods to compute the attrition. One method is the calculation of the churn rate. It is calculated by dividing the number of cardholders who stopped engaging with the merchant during a specific period by the total number of cardholders who were engaging with the merchant before that period. This calculation yields a percentage. Another method, Recency, Frequency, Monetary (RFM) analysis, assesses the cardholders based on how recently they used their card, how frequently they use it, and how much they spend. This helps identify the cardholders at risk of attrition by analyzing transaction behavior changes. Cardholder lifetime value is another approach that estimates the net profit a cardholder will generate for the merchant over their relationship with the merchant. A decline in the cardholder's lifetime value can indicate potential attrition. Lastly, survival analysis, a statistical method, models the probability of the attrition occurring over time, allowing the merchants to predict when the cardholders might stop using their cards.

Despite their utility, conventional methods for calculating attrition have limitations. The Churn rate and the RFM analysis are retrospective, meaning they identify attrition only after it has occurred, making it challenging for the merchants to intervene in time. Additionally, these methods often fail to capture complex behavioral patterns or external factors like competition and market shifts. Cardholder surveys and cardholder lifetime value models, while insightful, can be time-consuming and may not reflect the full range of reasons behind the attrition. Furthermore, conventional methods tend to be static, offering little real-time insight, which reduces their ability to predict and prevent attrition effectively.

Thus, a technological need exists for methods and systems for determining attrition at a merchant to facilitate the merchant to take proactive measures for preventing attrition.

### SUMMARY

Various embodiments of the present disclosure provide methods and systems for determining attrition at a merchant by addressing the drawbacks of the conventional methods for calculating attrition.

In an embodiment, a computer-implemented method for determining attrition at a merchant is disclosed. The computer-implemented method performed by a server system includes accessing information related to a subset of cardholders from a database associated with the server system. The computer-implemented method further includes generating a set of features for each cardholder in the subset of cardholders based, at least in part, on one or more transaction attributes associated with each transaction performed by each cardholder from the subset of cardholders. Further, the computer-implemented method includes generating an opt-out feature for each cardholder based, at least in part, on a historical transaction dataset. Herein, the opt-out feature indicates whether an individual cardholder has requested to cancel ongoing recurrent payments with the merchant. Additionally, the computer-implemented method includes generating, by a Machine Learning (ML) model associated with the server system, an attrition score for each cardholder of the subset of cardholders based, at least in part, on the corresponding set of features and the corresponding opt-out feature of each cardholder. Herein, the attrition score indicates a probability of each cardholder refraining from engaging in future transactions with the merchant.

In another embodiment, a server system is disclosed. The server system includes a communication interface and a memory including executable instructions. The server system also includes a processor communicably coupled to the memory. The processor is configured to execute the instructions to cause the server system, at least in part, to access information related to a subset of cardholders from a database associated with the server system. Further, the server system is caused to generate a set of features for each cardholder in the subset of cardholders based, at least in part, on one or more transaction attributes associated with each transaction performed by each cardholder from the subset of cardholders. Moreover, the server system is caused to generate an opt-out feature for each cardholder based, at least in part, on a historical transaction dataset. Herein, the opt-out feature indicates whether an individual cardholder has requested to cancel ongoing recurrent payments with a merchant. Also, the server system is caused to generate by a Machine Learning (ML) model associated with the server system an attrition score for each cardholder of the subset of cardholders based, at least in part, on the corresponding set of features and the corresponding opt-out feature of each cardholder. Herein, the attrition score indicates a probability of each cardholder refraining from engaging in future transactions with the merchant.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing information related to a subset of cardholders from a database associated with the server system. The method further includes generating a set of features for each cardholder in the subset of cardholders based, at least in part, on one or more transaction attributes associated with each transaction performed by each cardholder from the subset of cardholders. Further, the method includes generating an opt-out feature for each cardholder based, at least in part, on a historical transaction dataset. Herein, the opt-out feature indicates whether an individual cardholder has requested to cancel ongoing recurrent payments with a merchant. Additionally, the method includes generating, by a Machine Learning (ML) model associated with the server system, an attrition score for each cardholder of the subset of cardholders based, at least in part, on the corresponding set of features and the corresponding opt-out feature of each cardholder. Herein, the attrition score indicates a probability of each cardholder refraining from engaging in future transactions with the merchant.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3 illustrates a schematic representation of an architecture for determining attrition at a merchant, in accordance with an embodiment of the present disclosure;

FIG. 4 illustrates a process flow diagram depicting a method for determining attrition at a merchant, in accordance with an embodiment of the present disclosure;

FIG. 5 illustrates a simplified block diagram of an acquirer server, in accordance with an embodiment of the present disclosure;

FIG. 6 illustrates a simplified block diagram of an issuer server, in accordance with an embodiment of the present disclosure; and

FIG. 7 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

Unless otherwise explicitly stated, articles such as “a” or “an” should generally be interpreted to include one or more described items. Accordingly, phrases such as “a server system configured to” are intended to include one or more recited server systems/processors. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations” without other modifiers, typically means at least two recitations or two or more recitations).

The terms “account holder”, “user”, “cardholder”, “consumer”, and “buyer” are used interchangeably throughout the description and refer to a person who has a payment account or a payment card (e.g., credit card, debit card, etc.) associated with the payment account, that will be used by them at a merchant to perform a payment transaction. The payment account may be opened via an issuing bank or an issuer server.

The term “merchant”, used throughout the description, generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of protocols and procedures in order to process the transfer of money for various types of transactions. Payment networks are networks that connect an issuing bank with an acquiring bank to facilitate online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform or function as payment networks include those operated by payment processors.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. The payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description, refers to a financial account that is used to fund a financial transaction. Examples of the financial account include, but are not limited to, a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction or transfer of payment of a certain amount being initiated by the cardholder. More specifically, they refer to electronic financial transactions including, for example, online payment, payment at a terminal (e.g., Point of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

Various embodiments of the present disclosure provide methods, systems, electronic devices, and computer program products for determining attrition at a merchant. In a specific embodiment, a server system can be embodied within a payment server associated with a payment gateway. In an embodiment, the server system is a payment server associated with a payment network. The server system includes a processor and a memory.

In a non-limiting implementation, the server system is configured to access information related to a subset of cardholders from a database associated with the server system. Further, the server system is configured to generate a set of features for each cardholder in the subset of cardholders. The server system generates the set of features based, at least in part, on one or more transaction attributes associated with each transaction performed by each cardholder from the subset of cardholders. Moreover, the server system is configured to generate an opt-out feature for each cardholder. The server system is configured to generate an opt-out feature based, at least in part, on a historical transaction dataset. Herein, the opt-out feature indicates whether an individual cardholder has requested to cancel ongoing recurrent payments with the merchant. Also, the server system is configured to generate an attrition score for each cardholder of the subset of cardholders. The server system is configured to generate the attrition score based, at least in part, on the corresponding set of features and the corresponding opt-out feature of each cardholder. The server system utilizes a Machine Learning (ML) model associated with the server system for generating the attrition score. Herein, the attrition score indicates a probability of each cardholder refraining from engaging in future transactions with the merchant.

Further, the server system is configured to access the historical transaction dataset from the database associated with the server system. Herein, the historical transaction dataset includes one or more transaction attributes related to a set of transactions performed between a set of cardholders and the merchant. Furthermore, the server system is configured to identify the subset of cardholders from the set of cardholders based, at least in part, on predefined criteria. Herein, the subset of cardholders includes at least one cardholder transacting regularly with the merchant. Moreover, the server system is configured to store the information related to the subset of cardholders in the database.

Additionally, the server system is configured to receive the one or more recurrent transaction cancellation requests associated with the merchant from the one or more cardholders. Also, the server system is configured to store the one or more recurrent transaction cancellation requests in the historical transaction dataset.

Further, the server system is configured to generate an alternate merchant feature for each cardholder. The server system generates the alternate merchant features based, at least in part, on the one or more transaction attributes associated with each transaction performed by each cardholder. Herein, the alternate merchant feature indicates whether an individual cardholder performs at least one transaction at another merchant. Moreover, the server system is configured to compute by the ML model, the attrition score based, at least in part, on the set of features, the opt-out feature, and the alternative merchant feature.

Additionally, the server system is configured to generate a cardholder inactivity feature for each cardholder. The server system generates the cardholder inactivity feature based, at least in part, on the one or more transaction attributes associated with each transaction performed by each cardholder. Herein, the cardholder inactivity feature indicates whether an individual cardholder has not performed a transaction for a predefined time period. Further, the server system is configured to compute, by the ML model, the attrition score based, at least in part, on the set of features, the opt-out feature, and the cardholder inactivity feature.

Furthermore, the server system is configured to receive a prediction request for an individual cardholder from the merchant. Moreover, the server system is configured to generate, by the ML model, a prediction associated with the individual cardholder. The server system generates the prediction based, at least in part, on the attrition score associated with the individual cardholder. Herein, the prediction indicates a probability of the individual cardholder refraining from engaging in future transactions with the merchant. Additionally, the server system is configured to transmit the attrition score for each cardholder of the subset of cardholders to the merchant. Further, the server system is configured to generate a visualization for representing the attrition score on a display associated with an electronic device of the merchant.

Furthermore, the server system is configured to receive a training dataset, including a set of data samples. Here, each data sample includes a set of training features and an associated target value. Moreover, the server system is configured to initialize an ensemble of decision trees present in the ML model. Herein, each decision tree is associated with a weight. Additionally, the server system is configured to train each tree in a predefined sequence based, at least in part, on performing a set of operations iteratively till the ML model achieves predefined criteria. Herein, the set of operations can include (i) generating, by a decision tree, a training prediction based, at least in part, on the set of training features; (ii) computing, by the ML model, a prediction residual based, at least in part, on comparing the training prediction with the associated target value; (iii) assigning a weight to each data sample based, at least in part, on the prediction residual; (iv) generating, by the ML model, another decision tree based, at least in part, on each weighted data sample to minimize a loss function; and (v) optimizing the weight associated with the another decision tree based, at least in part, on an overall prediction error generated by the ensemble of trees.

Various embodiments of the present disclosure offer multiple advantages and technical effects. For instance, the present invention aims to generate an attrition score for each cardholder in a subset of cardholders, leveraging the historical transaction data of each cardholder as a key input. Specifically, the proposed approach employs a Machine Learning (ML) model to generate the attrition score. The generated attrition score provides a predictive indication of potential cardholder attrition, enabling merchants to take proactive measures to mitigate attrition in a timely manner. Moreover, the proposed approach enhances accuracy by identifying and capturing intricate patterns and relationships embedded within the historical transaction data of the cardholders. Additionally, this method demonstrates high efficiency, by delivering attrition scores with minimal latency by utilizing the optimized performance of the ML model, ensuring near-instantaneous generation of results. The proposed approach generates an attrition score for each cardholder based, at least in part, on features such as an opt-out feature, an alternate merchant feature, and a cardholder inactivity feature. Here, the opt-out feature facilitates the ML model to generate the attrition score by capturing an explicit choice made by a cardholder while opting out from performing further transactions at the merchant. While the alternate merchant feature and the cardholder inactivity features facilitate the ML model to generate the attrition score based, at least in part, on the implicit transaction patterns of the cardholder. This combination of implicit and explicit features ensures a more accurate and comprehensive attrition score.

Considering a non-limiting example of a subscription-based video streaming firm. The subscription-based video streaming firm relies on conventional methods for identifying attrition among its subscribers. However, the conventional methods can identify attrition only after the subscribers have stopped engaging with the firm. This makes it difficult for the firm to take any corrective actions to prevent the attrition of the subscribers.

Now, to address the shortcomings of the conventional methods, an application of the approach provided by the various embodiments described herein can be utilized. In particular, a server system is configured to generate a number of features utilizing historical transaction data associated with the subscribers. The number of features can be an opt-out feature, an alternate merchant feature, and a cardholder inactivity feature. Here, the opt-out feature facilitates the ML model to generate the attrition score by capturing an explicit choice made by a subscriber while opting out from performing further transactions at the subscription-based video streaming firm. Further, the alternate merchant features and the cardholder inactivity features facilitate the ML model to generate the attrition score based, at least in part, on the implicit transaction patterns of the subscriber. This combination of implicit and explicit features facilitates the ML model to generate a more accurate and comprehensive attrition score. The attrition score thus generated is predictive in nature, thereby facilitating the firm to make timely interventions to retain the subscribers who are likely to refrain from engaging with the firm in the future.

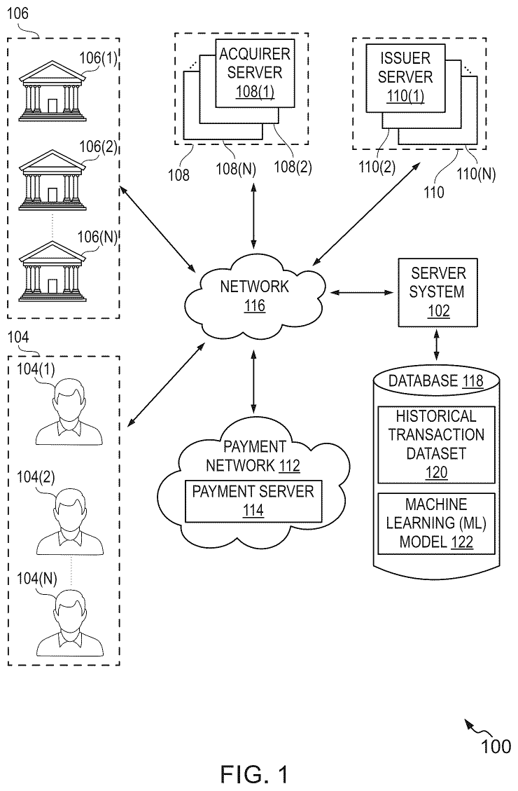

Various example embodiments of the present disclosure are described hereinafter with reference to FIG. 1 to FIG. 7.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, determining attrition at a merchant 106(1) and the like.

The environment 100 generally includes a plurality of components such as a server system 102, a payment network 112 including a payment server 114, a database 118, a plurality of entities such as a plurality of cardholders 104(1), 104(2), . . . 104(N) (collectively, referred to as the ‘plurality of cardholders 104’ and ‘N’ is a Natural number), a plurality of merchants 106(1), 106(2), . . . , 106(N) (collectively, referred to as the ‘plurality of merchants 106’ and ‘N’ is a Natural number), a plurality of acquirers 108(1), 108(2), . . . , 108(N) (collectively, referred to as the ‘plurality of acquirers 108’ and ‘N’ is a Natural number), a plurality of issuers 110(1), 110(2), . . . , 110(N) (collectively, referred to as the ‘plurality of issuers 110’ and ‘N’ is a Natural number), a historical transaction dataset 120, and a Machine Learning (ML) model 122 each coupled to, and in communication with (and/or with access to) a network 116. Herein, the payment network 112 indicates a network that connects an issuing bank with an acquiring bank to facilitate payment, and the payment server 114 is responsible for facilitating the various operations of the payment network 112.

It is noted that these entities may be classified or segregated based, at least in part, on their relationship in the payment network 112 or the network 116 with each other in the payment ecosystem. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the plurality of acquirer 108 (also referred as the ‘acquirer servers 108’), the plurality of issuers 110 (also referred as the ‘issuer servers 110’), and the payment server 114 may communicate.

In an embodiment, the plurality of cardholders 104 (or the ‘cardholders 104’) uses one or more payment cards to make payment transactions at the plurality of merchants 106 (or the ‘merchants 106’). A cardholder (e.g., the cardholder 104(1)) may be any individual, representative of a corporate entity, a non-profit organization, or any other person that is presenting payment account details during an electronic payment transaction with a merchant (e.g., the merchant 106(1)). The cardholder (e.g., the cardholder 104(1)) may have a payment account issued by an issuing bank (not shown in figures) associated with an issuer server (e.g., the issuer server 110(1)) from the plurality of the issuer servers 110 (explained later) and may be provided a payment card with financial or other account information encoded onto the payment card such that the cardholder (i.e., the cardholder 104(1)) may use the payment card to initiate and complete a payment transaction using a bank account at the issuing bank.

In an example, the cardholders 104 may use their corresponding electronic devices (not shown) to access a mobile application or a website associated with the issuing bank or any third-party payment application. In various non-limiting examples, electronic devices may refer to any electronic devices such as, but not limited to, Personal Computers (PCs), tablet devices, Personal Digital Assistants (PDAs), voice-activated assistants, Virtual Reality (VR) devices, smartphones, and laptops.

In an embodiment, the merchants 106 may include retail shops, restaurants, supermarkets or establishments, government and/or private agencies, or any such places equipped with POS terminals, where an individual such as the cardholders 104 visit to perform the financial transaction in exchange for any goods and/or services or any financial transactions.

In one scenario, the cardholders 104 may use their corresponding payment accounts or payment cards to conduct payment transactions with the merchants 106. Moreover, it may be noted that each of the cardholders 104 may use their corresponding payment card from the payment cards differently or make the payment transaction using different means of payment. For instance, the cardholder 104(1) may enter payment account details on an electronic device (not shown) associated with the cardholder 104(1) to perform an online payment transaction. In another example, the cardholder 104(2) may utilize the payment card to perform an offline payment transaction. For example, the cardholder 104(1) may enter details of the payment card to transfer funds in the form of fiat currency on an e-commerce platform to buy goods. In another instance, each cardholder (e.g., the cardholder 104(1)) of the cardholders 104 may transact at any merchant (e.g., the merchant 106(1)) from the merchants 106.

In one embodiment, the cardholders 104 are associated with the plurality of issuer servers 110 (or the ‘issuer servers 110’). In one embodiment, an issuer server such as the issuer server 110(1) is associated with a financial institution normally called an “issuer bank”, “issuing bank,” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the merchants 106 are associated with the plurality of acquirer servers 108. In an embodiment, each merchant (e.g., the merchant 106(1)) is associated with an acquirer server (e.g., the acquirer server 108(1)). In one embodiment, the acquirer server 108(1) is associated with a financial institution (e.g., a bank) that processes financial transactions for the merchant 106(1). This can be an institution that facilitates the processing of payment transactions for physical stores, merchants (e.g., the merchant 106(1)), or institutions that own platforms that make either online purchases or purchases made via software applications possible (e.g., shopping cart platform providers and in-app payment processing providers). The terms “acquirer”, “acquiring bank”, “acquiring bank,” or “acquirer server” will be used interchangeably herein.

As described earlier, attrition refers to a gradual reduction in the number of cardholders engaging with a merchant over time. The attrition is a crucial metric for merchants as it impacts revenue and retention strategies. To assess the chances of attention, the merchants utilize metrics like churn rate, RFM (Recency, Frequency, Monetary) analysis, and cardholder lifetime value. While these conventional approaches provide insights, they have notable limitations.

Churn rate and RFM analysis are reactive, identifying attrition only after it occurs, making early intervention difficult. These methods also overlook complex behavioral patterns and external factors, like competition, which can contribute to attrition. Additionally, they offer limited real-time insights, reducing their effectiveness in proactively preventing attrition. As a result, merchants may struggle to adjust their strategies swiftly to retain cardholders, missing opportunities to address dissatisfaction before the cardholders leave.

The above-described technical problem, among other problems, is addressed by one or more embodiments implemented by the server system 102 of the present disclosure. In one embodiment, the server system 102 is configured to perform one or more of the operations described herein.

In an embodiment, the server system 102 may be coupled to the database 118. In one embodiment, the database 118 may be incorporated in the server system 102, or may be an individual entity connected to the server system 102, or may be the database 118 stored in cloud storage. In various non-limiting examples, the database 118 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database 118. In one implementation, the database 118 may be viewed, accessed, amended, updated, and/or deleted by an administrator (not shown) associated with the server system 102 through a database management system (DBMS) or Relational DBMS (RDBMS) present within the database 118.

In an embodiment, the database 118 may store the historical transaction dataset 120 and the ML model 122. As may be understood, the historical transaction dataset 120 indicates a dataset that stores clearing data and authentication data associated with each cardholder in a subset of cardholders. Herein, the ML model 122 indicates an Artificial Intelligence model that is responsible for generating the attrition score for the cardholder. In various examples, the ML model 122 may include, but is not limited to, Graph Neural Networks (GNNs), Graph Convolutional Networks (GCNs), Large Language Models (LLMs), Random Forest models, Support Vector Machine (SVM) models, Convolutional Neural Networks (CNNs), Recurrent Neural Network (RNN) models, Transformer models, and the like.

In one embodiment, the database 118 may be incorporated in the server system 102 or may be an individual entity connected to the server system 102 or may be a database stored in cloud storage.

In a non-limiting implementation, for generating the attrition score for each cardholder in the subset of cardholders, the server system 102 accesses the information related to a subset of cardholders. Herein, the term ‘attrition score’ indicates a probability of each cardholder refraining from transacting at the merchant 106(1). Herein, the information related to the subset of cardholders can include one or more transaction attributes associated with each transaction performed by each cardholder with the merchant 106(1). In various examples, the one or more transaction attributes may include, but are not limited to, transaction date, transaction time, merchant name, merchant address, country, city, Permanent Account Number (PAN), transaction amount, Dynamic Currency Conversion (DCC) transaction amount, and the like.

Further, the server system 102 is configured to generate a set of features for each cardholder in the subset of cardholders based, at least in part, on one or more transaction attributes. Here, the term ‘set of features’ indicates measurable characteristics derived from the one or more transaction attributes that represent important aspects of the transaction behavior of each cardholder. In various examples, the set of features may include, but is not limited to, transaction amount, card not present transaction, card-present transaction, recurrent transaction, domestic transaction, international transaction, same merchant transaction, same industry transaction, transaction with another merchant having same Merchant Category Code (MCC), and the like. In one embodiment, the server system 102 is configured to generate the set of features by considering different time periods such as weeks, months, and years. In another embodiment, the server system 102 is configured to generate the set of features on a cumulative basis, aggregating the one or more transaction attributes over time. Here, the set of features provides information regarding various transactional behaviors of each cardholder.

Moreover, the server system 102 is configured to generate an opt-out feature for each cardholder based, at least in part, on the historical transaction dataset 120. Here, the term ‘each cardholder’ refers to each cardholder in the subset of cardholders. Herein, the opt-out feature indicates whether an individual cardholder has requested to cancel ongoing recurrent payments with the merchant 106(1). For generating the optout feature, the server system 102 performs a series of operations. The series of operations may be initiated by accessing the historical transaction dataset 120. Then, the server system 102 identifies one or more recurrent transaction cancellation requests associated with the merchant 106(1) and come from one or more cardholders in the subset of cardholders.

Herein, the term ‘recurrent transaction cancellation request’ refers to a request raised by a cardholder 104(1). This request is made to the payment network 112 to cancel an automatic debit mandate. Here, the automatic debit mandate authorizes the merchant 106(1) to deduct a specific amount from the bank account associated with the cardholder 104(1). The server system 102 generates the opt-out feature for the one or more cardholders who has raised one or more recurrent cancellation requests, by assigning a first state to the opt-out feature. Also, the server system 102 generates the opt-out features for each of the remaining cardholders in the subset of cardholders by setting a second state to the opt-out feature. Here, the first state and the second state can be either 0 or 1, and vice versa.

Consider an exemplary scenario in which an individual cardholder A has been transacting with merchant 106(1) using the automatic debit mandate (recurrent payments). Later, the cardholder A can raise a recurrent transaction cancellation request to the payment network 112 to cancel the automatic debit mandate to stop recurrent transactions with the merchant 106(1). The recurrent transaction cancellation request raised by the cardholder A will be stored in the historical transaction dataset 120. The recurrent transaction cancellation request can be utilized by the server system 102 to generate the opt-out feature for the cardholder A. Here, the opt-out feature provides explicit information to the ML model 122 regarding a choice made by a cardholder to refrain from future transactions with the merchant 106(1). This helps to improve the accuracy of the ML model 122 while generating the attrition score.

In response to noticing the recurrent transaction cancellation request from the cardholder A, the server system 102 may generate the opt-out feature for the cardholder A. Herein, the opt-out feature can indicate that the cardholder A is no longer interested in transacting at the merchant 106(1). Further, the server system 102 may assign a first state to the opt-out feature associated with the cardholder A. Further, the server system 102 utilizes the ML model 122 to generate the attrition score for each cardholder of the subset of cardholders. The server system 102 is configured to generate the attrition score based, at least in part, on the corresponding set of features and the corresponding opt-out feature of each cardholder.

In other words, the server system 102 generates the attrition score for each cardholder based, at least in part, on the corresponding set of features and the corresponding opt-out feature of each cardholder. Herein, the corresponding set of features is derived based, at least in part, on intrinsic transaction patterns between each cardholder and the merchant 106(1). Here, the corresponding opt-out feature is derived based, at least in part, on an explicit choice made by each cardholder.

Consider an exemplary scenario in which an online fitness subscription service where a number of cardholders subscribe to receive monthly workouts, diet plans, and live coaching sessions. Many of them enable automatic monthly payments to maintain subscriptions. The server system 102 can access transaction information related to a subset of these cardholders to generate a set of features for each cardholder. The server system 102 also identifies recurrent transaction cancellation requests raised by some of the cardholders to cancel their automatic payments. The server system 102 further generates the opt-out feature for each cardholder based, at least in part, on the one or more recurrent transaction cancellation requests. Further, the server system 102 utilizes the ML model 122 to generate the attrition score for each cardholder using the opt-out feature of each cardholder and the corresponding set of features and other transactional behaviors. This attrition score can be later utilized by the fitness subscription service to anticipate the attrition of certain cardholders. This helps the fitness subscription service to take proactive measures to retain those cardholders who are likely to attrite.

Here, the attrition score generated by the server system 102 is capable of anticipating the attrition that can happen in the future, facilitating the merchants 106 to make timely interventions to prevent the attrition. This benefits the merchants 106 by fostering customer loyalty, enhancing revenue stability, and reducing acquisition costs.

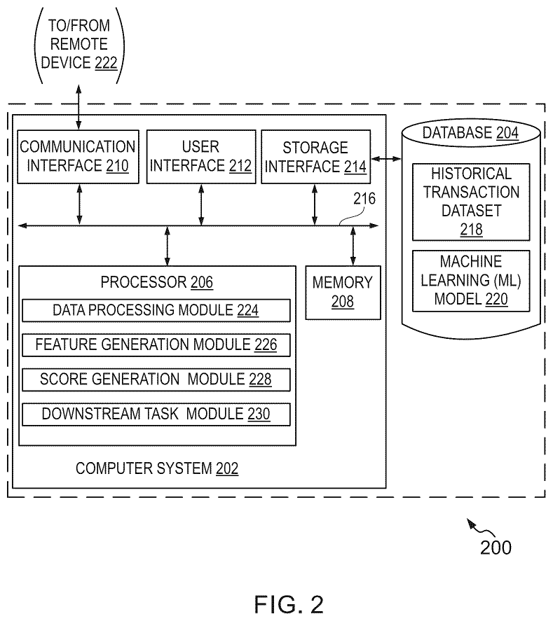

It is noted that the various aspects described with reference to FIG. 1 have been described further in detail with FIG. 2 later in the present disclosure.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

FIG. 2 illustrates a simplified block diagram of a server system 200, in accordance with an embodiment of the present disclosure. The server system 200 is identical to the server system 102, described with reference to FIG. 1. The server system 200 can be a payment server 114 associated with the payment network 112. In some embodiments, the server system 200 is embodied as a cloud-based and/or software as a service (SaaS)-based architecture.

The server system 200 includes a computer system 202 and a database 204. The computer system 202 includes at least one processor 206 (herein, referred to interchangeably as the ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive, and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one non-limiting example, the database 204 is configured to store a historical transaction dataset 218 and a Machine Learning (ML) model 220. Here, the historical transaction dataset 218 is substantially similar to the historical transaction dataset 120 described with reference to FIG. 1. Here, the ML model 220 is identical to the ML model 122 described with reference to FIG. 1.

In addition, the database 204 provides a storage location for data and/or metadata obtained from various operations performed by the server system 200. In one embodiment, the database 204 is substantially similar to the database 118 of FIG. 1. Thus, it should be understood that all the details, data, or information as described in the description of FIG. 1 to be stored in the database 118 apply to the database 204 as well.

Further, the computer system 202 may include one or more hard disk drives as the database 204. The user interface 212 is an interface, such as a Human Machine Interface (HMI) or a software application, that allows users, such as the administrator, to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for generating the attrition score for cardholders 104 and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200 without departing from the scope of the present disclosure.

The processor 206 is operatively coupled to the communication interface 210, such that the processor 206 is capable of communicating with a remote device 222, such as the issuer servers 110, the acquirer servers 108, the payment network 112, or communicating with any entity connected to the network 116 (as shown in FIG. 1).

It is noted that the server system 200, as illustrated and hereinafter described, is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data processing module 224, a feature generation module 226, a score generation module 228, and a downstream task module 230. It should be noted that components described herein, such as the data processing module 224, the feature generation module 226, the score generation module 228, and the downstream task module 230, can be configured in a variety of ways, including electronic circuitries, digital arithmetic, and logic blocks, and memory systems in combination with software, firmware, and embedded technologies. Moreover, it may be noted that the data processing module 224, the feature generation module 226, the score generation module 228, and the downstream task module 230 may be communicably coupled with each other to exchange information with each other for performing the one or more operations facilitated by the server system 200.

In an embodiment, the data processing module 224 includes suitable logic and/or interfaces for accessing the historical transaction dataset 218 from the database 204 associated with the server system 200. Herein, the historical transaction dataset 218 includes one or more transaction attributes related to a set of transactions performed between a set of cardholders and the merchant 106(1). Herein, the term ‘transaction attributes’ indicates specific data points or characteristics associated with the set of transactions. Further, the data processing module 224 is configured to identify a subset of cardholders from a set of cardholders based, at least in part, on predefined criteria. In various examples, the predefined criteria may include, but are not limited to, frequency of transactions, transaction interval consistency, spending patterns, recurring billing dates, total spend threshold, last transaction recency, transaction type, location consistency, days since the first transaction, category-specific patterns, and the like. Herein, the subset of cardholders indicates at least one cardholder transacting regularly with the merchant 106(1). Further, the data processing module 224 stores information related to the subset of cardholders in the database 204. The information can include the one or more transaction attributes associated with each transaction performed by each cardholder from the subset of cardholders.

Consider an exemplary scenario in which, the set of cardholders performing the set of transactions with the merchant 106(1) can include the cardholder A, a cardholder B, and a cardholder C. The transaction attributes related to each of these cardholders will be available in the historical transaction dataset 218. The data processing module 224 identifies specific cardholders from the set of cardholders based, at least in part, on the predefined criteria. Here, the predefined criteria can be cardholders having consistent transaction intervals with the merchant 106(1). Here, among the set of cardholders, the cardholder B may have a consistent transaction interval with the merchant 106(1). Hence, the data processing module 226 stores information related to the cardholder B in the database 204. The information related to the cardholder B can be the one or more transaction attributes associated with each transaction performed by the cardholder B.

In an embodiment, the feature generation module 226 includes suitable logic and/or interfaces for generating a set of features for each cardholder in the subset of cardholders. The feature generation module 226 generates the set of features based, at least in part, on the information. Further, the feature generation module 226 is configured to receive the one or more recurrent transaction cancellation requests associated with the merchant from the one or more cardholders. Then, the feature generation module 226 stores the one or more recurrent transaction cancellation requests in the historical transaction dataset 218.

Further, the feature generation module 226 is configured to generate the opt-out feature for each cardholder based, at least in part, on the historical transaction dataset 218. Herein, the term ‘opt-out feature’ indicates whether an individual cardholder has requested to cancel ongoing recurrent payments with the merchant 106(1). For generating the opt-out feature, the feature generation module 226 performs a series of operations. The series of operations may be initiated by accessing the historical transaction dataset 218. Then, the feature generation module 226 identifies one or more recurrent transaction cancellation requests associated with the merchant 106(1) and come from one or more cardholders in the subset of cardholders. Further, the feature generation module 226 generates the opt-out feature for the one or more cardholders who has raised one or more recurrent cancellation requests. This is done by assigning a first state to the opt-out feature associated with each of the one or more cardholders. Also, the feature generation module 226 generates the opt-out feature associated with each of the remaining cardholders in the subset of cardholders by setting the second state to the opt-out feature. Here, the first state and the second state can be either 0 or 1, and vice versa.

Returning to the previous exemplary scenario, the feature generation module 226 generates the set of features based, at least in part, on the information associated with the cardholder B. In various examples, the set of features may include, but is not limited to, transaction amount, card not present transaction, card-present transaction, recurrent transaction, domestic transaction, international transaction, same merchant transaction, same industry transaction, transaction with another merchant having same MCC, and the like. Consider a scenario in which the cardholder B has been performing recurrent transactions with the merchant 106(1) for specific services. Now, the cardholder B has decided to cancel the recurrent transactions. For canceling the recurrent transactions, the cardholder B raises a recurrent transaction cancellation request. The feature generation module 226 receives this request and stores the request in the historical transaction dataset 218. Later, when generating the opt-out feature for the cardholder B, the feature generation module 226 checks the historical transaction dataset 218. The feature generation module 226 examines whether the cardholder B has raised a recurrent transaction cancellation request. If the feature generation module 226 notices that the cardholder B has raised such a request, it can set the opt-out feature associated with the cardholder B to the first state.

In an embodiment, the feature generation module 226 is configured to generate an alternate merchant feature for each cardholder. The alternate merchant feature is generated based, at least in part, on the one or more transaction attributes associated with each transaction performed by each cardholder. Herein, the alternate merchant feature indicates whether an individual cardholder performs at least one transaction at another merchant. Herein, the term ‘another merchant’ refers to a merchant that is different from the merchant 106(1). More specifically, the feature generation module 226 checks the one or more transaction attributes associated with each transaction performed by each cardholder. This check is performed for identifying one or more cardholders who are transacting with another merchant 106(2) other than the merchant 106(1). Then, the feature generation module 226 assigns a first state to the alternate merchant feature associated with each of the one or more cardholders transacting with the another merchant 106(2). Also, the feature generation module 226 assigns the second state to the alternate merchant feature associated with each of the remaining cardholders in the subset of cardholders. Returning to the previous exemplary scenario, if cardholder B is transacting with a different merchant 106(2), rather than the merchant 106(1). In this case, the feature generation module 226 generates the alternate merchant feature for the cardholder B and assigns the first state to the alternate merchant feature.

In yet another embodiment, the feature generation module 226 is configured to generate a cardholder inactivity feature for each cardholder. The cardholder inactivity feature is generated based, at least in part, on the one or more transaction attributes associated with each transaction performed by each cardholder. Herein, the cardholder inactivity feature indicates whether an individual cardholder has not performed a transaction for a predefined time period. More specifically, the feature generation module 226 accesses the one or more transaction attributes associated with each transaction performed by each cardholder. Then, the feature generation module 226 identifies one or more cardholders who have not performed a transaction for the predefined time period. Herein, the predefined time can be defined by the administrator.

Further, the feature generation module 226 may assign the first state to the cardholder inactivity feature associated with each of the one or more cardholders identified by the feature generation module 226. Also, the feature generation module 226 assigns the second state to the cardholder inactivity feature associated with each of the remaining cardholders present in the subset of cardholders. Returning to the previous exemplary scenario, the cardholder B may not be performing any transaction for the predefined time period. In such a scenario, the feature generation module 226 can identify the cardholder B from the subset of cardholders. Further, the feature generation module 226 generates the cardholder inactivity feature for the cardholder B and assigns the first state to the cardholder inactivity feature.

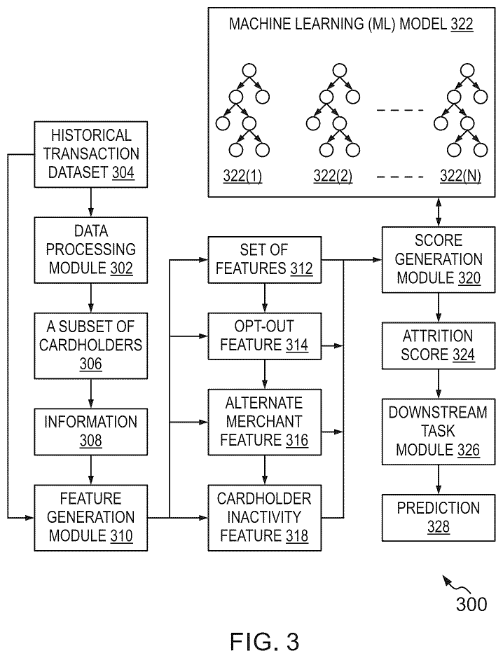

In an embodiment, the score generation module 228 includes suitable logic and/or interfaces for generating the attrition score for each cardholder of the subset of cardholders. The score generation module 228 generates the attrition score based, at least in part, on the corresponding set of features, and the corresponding opt-out feature of each cardholder. In particular, for generating the attrition score, the score generation module 228 utilizes the ML model 220. In an example, the ML model 220 can be an Xtreme Gradient Boosting (XGBoost) model. More specifically, the ML model 220 can include a number of decision trees. Each decision tree generates an individual attrition score based, at least in part, on the corresponding set of features, and the corresponding opt-out feature of each cardholder. Later, the individual attrition score generated by each decision tree is aggregated to generate the attrition score for each cardholder. The training process of the XGBoost model is described in detail with reference to FIG. 3.

Returning to the previous exemplary scenario, the score generation module 228 generates the attrition score for the cardholder B based, at least in part, on the corresponding set of features and the opt-out feature associated with the cardholder B. In one embodiment, the score generation module 228 can generate the attrition score for the cardholder B based, at least in part, on the set of features, the opt-out feature, and the cardholder inactivity feature. In yet another embodiment, the score generation module 228 can generate the attrition score for the cardholder B based, at least in part, on the set of features, the opt-out feature, and the alternative merchant feature.

In an embodiment, the downstream task module 230 includes suitable logic and/or interfaces for generating a prediction associated with an individual cardholder. Herein, the prediction indicates a probability of the individual cardholder refraining from engaging in future transactions with the merchant 106(1). In particular, for generating the prediction, the downstream task module 230 receives a prediction request from the merchant 106(1). In response to the prediction request, the downstream task module 230 utilizes the ML model 220 for generating the prediction. The ML model 220 is configured to generate the prediction based, at least in part, on the attrition score associated with the individual cardholder. More specifically, the ML model 220 checks whether the attrition score is at least equal to a predefined attrition threshold. If the attrition score associated with the individual cardholder is at least equal to the predefined attrition threshold, then the ML model 220 may predict that the individual cardholder is likely to attrite.

Returning to the previous example scenario, the merchant 106(1) can raise a prediction request to the downstream task module 230 for generating the prediction associated with the cardholder B. In response to receiving the prediction request, the downstream task module 230 employs the ML model 220 for generating the prediction. The ML model 220 checks whether the attrition score associated with the cardholder B is at least equal to the predefined attrition threshold. In an instance, the attrition score associated with the cardholder B can be 0.90, and the predefined attrition threshold can be 0.75. In such a scenario, the ML model 220 generates the prediction indicating the possible attrition of the cardholder B. This is because the attrition score associated with cardholder B is higher than the predefined attrition threshold.

Further, the downstream task module 230 is configured to transmit the attrition score for each cardholder of the subset of cardholders to the merchant. Returning to the previous example, the downstream task module 230 transmits the attrition score associated with the cardholder B to the merchant 106(1).

Furthermore, the downstream task module 230 is configured to generate a visualization for representing the attrition score on a display associated with an electronic device of the merchant 106(1). In various examples, the visualization may include, but is not limited to, a heatmap, a bar chart, a line chart, a gauge chart, a stacked area chart, a choropleth map, a histogram, a box plot, a scatter plot, a waterfall chart, a clustered bar chart, a Sankey diagram. In various examples, the electronic device may include, but is not limited to, a phone, a laptop, a Personal Digital Assistant (PDA), and the like.

To summarize, the server system 200 is configured to generate the attrition score for each cardholder from the subset of cardholders. The attritions score is generated based, at least in part, on various features derived from the historical transaction dataset 218. Herein, the various features can include the opt-out feature, the alternate merchant feature, and the cardholder inactivity feature. The opt-out feature captures the cardholder's explicit decision to discontinue transactions with the merchant 106(1). In contrast, the alternate merchant feature and the cardholder inactivity features capture the likelihood of the attrition by leveraging implicit transaction patterns of each cardholder. By integrating these explicit and implicit features, the ML model 222 generates a more precise and comprehensive attrition score for each cardholder. The attrition score thus generated facilitates the merchants 106 to anticipate the attrition of various cardholders. In such a scenario, the merchants 106 can take countermeasures to prevent the attrition by anticipating the attrition.

FIG. 3 illustrates a schematic representation of an architecture 300 for determining attrition at merchant, in accordance with an embodiment of the present disclosure. As described earlier, for determining attrition at the merchant, a data processing module 302 accesses a historical transaction dataset 304. Herein, the data processing module 302 is identical to the data processing module 224 described with reference to FIG. 2. Here, the historical transaction dataset 304 is identical to the historical transaction dataset 218 described with reference to FIG. 2. Herein, the historical transaction dataset 304 includes the one or more transaction attributes related to the set of transactions performed between a set of cardholders and a merchant 106(1). Further, the data processing module 302 identifies the subset of cardholders 306 who are transacting regularly with the merchant 106(1) from the set of cardholders. Then, the data processing module 302 accesses the information 308 related to the subset of cardholders 306. Herein, the information 308 can include one or more transaction attributes associated with each transaction performed by each cardholder from the subset of cardholders 306.

Moreover, a feature generation module 310 utilizes the information 308 to generate a set of features 312. Herein, the feature generation module 310 is identical to the feature generation module 226 described with reference to FIG. 2. Further, the feature generation module 310 generates an opt-out feature 314, an alternate merchant feature 316, and a cardholder inactivity feature 318. The process of generating these features is described in detail with reference to FIG. 2. Hence, for the sake of brevity, the process is not explained herein.

Further, the score generation module 320 utilizes an ML model 322 to generate the attrition score 324 for each cardholder from the subset of cardholders 306. For generating the attrition score 324, the score generation module 320 trains the ML model 322. For training the ML model 322, the score generation module 320 receives a training dataset, including a set of data samples. Herein, each data sample includes a set of training features and an associated target value. For example, the set of training features can include a cardholder who has opted out, no transactions in the last three months, the cardholder is transacting with a different merchant and the like. Here, the associated target value can be 0.75, indicating a high attrition chance for the cardholder.

Further, the score generation module 320 initializes an ensemble of decision trees (see, 322(1), 322(2) . . . 322(N), where N is a non-zero natural number) present in the ML model 322. Herein, each decision tree is associated with a weight. In an exemplary scenario, the ML model 322 can have ten decision trees. The score generation module 320 initializes each tree with a weight of 1. Furthermore, the score generation module 320 trains each tree in a predefined sequence. The training is based, at least in part, on performing a set of operations iteratively till the ML model 322 achieves predefined criteria. Herein, the predefined criteria can be defined by the administrator.

Moreover, the set of operations can include generating a training prediction by a decision tree based, at least in part, on the set of training features. Returning to the previous exemplary scenario, the first tree can generate a training prediction of 0.65. Then, the ML model 322 generates a prediction residual based, at least in part, on comparing the training prediction with the associated target value. Returning to the previous exemplary scenario, the prediction residual can be 0.10, indicating that the ML model 322 underestimated the associated target value by 0.10. Further, the score generation module 320 is configured to assign a weight to each data sample based, at least in part, on the prediction residual. Returning to the previous exemplary scenario, the ML model 322 underestimated the associated target value by generating the training prediction of 0.65. As a result, the data sample containing the set of training features that contributed to the training prediction will receive a higher weight. Another data sample that generates a smaller prediction residual will receive a smaller weight.

Further, the ML model 322 generates another decision tree based, at least in part, on each weighted data sample to minimize a loss function. In this step, the another decision tree might generate the training prediction as 0.73 instead of 0.65 for the same data sample, thus moving the training prediction closer to the associated target value. Later, the score generation module 320 optimizes the weight associated with the another decision tree based, at least in part, on an overall prediction error generated by the ensemble of trees. For generating the overall prediction error, the score generation module 320 performs a series of operations. The series of operations may be initiated by computing an overall attrition score by aggregating the training prediction generated by each decision tree. Then, the score generation module 320 is configured to compute the overall prediction error based, at least in part, on comparing the overall attrition score with the associated target value.

Upon completing the training, the ML model 322 is deployed to generate the attrition score 324 for each cardholder. The ML model 322 generates the attrition score 324 for each cardholder based, at least in part, on the set of features 312, the opt-out feature 314, the alternate merchant feature 316, and the cardholder inactivity feature 318. In particular, the score generation module 320 provides these features to each decision tree. In response to that, each decision tree generates an individual attrition score. Further, the individual attrition score generated by each decision tree is aggregated by the score generation module 320 to generate the attrition score 324. In a non-limiting example, the attrition score may be computed using the following equation:

$$\hat{y} = {\sum }_{k = 1}^{K} {f}_{k} ( x ) \qquad Eqn . ( 1 )$$

Herein, ‘ŷ’ indicates the attrition score, ‘K’ indicates the number of decision trees, ‘x’ indicates the features provided to each decision tree. Later, a downstream task module 326 can utilize the attrition score 324 associated with an individual cardholder to generate a prediction 328 associated with the individual cardholder. This prediction 328 is generated in response to receiving a prediction request for the individual cardholder from the merchant 106(1).

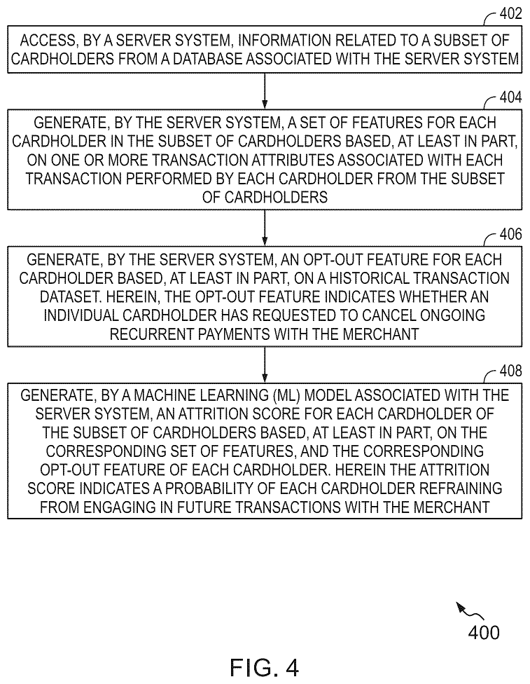

FIG. 4 illustrates a process flow diagram depicting a method 400 for determining attrition at a merchant 106(1), in accordance with an embodiment of the present disclosure. The method 400 depicted in the flow diagram may be executed by, for example, the server system 200. The sequence of operations of the method 400 may not be necessarily executed in the same order as they are presented. Further, one or more operations may be grouped and performed in the form of a single step, or one operation may have several sub-steps that may be performed in parallel or in a sequential manner. Operations of the method 400, and combinations of operations in the method 400 may be implemented by, for example, hardware, firmware, a processor, circuitry, and/or a different device associated with the execution of software that includes one or more computer program instructions. The plurality of operations is depicted in the process flow of the method 400. The process flow starts at operation 402.

At operation 402, the method 400 includes accessing, by a server system 200, information related to a subset of cardholders from a database 204 associated with the server system 200. Here, the term ‘subset of cardholder’ refers to a number of cardholders transacting regularly with a merchant 106(1). Herein, the information indicates transactional information associated with the subset of cardholders.

At operation 404, the method 400 includes generating, by the server system 200, a set of features for each cardholder in the subset of cardholders. The set of features is generated based, at least in part, on one or more transaction attributes associated with each transaction performed by each cardholder from the subset of cardholders. Herein, the term ‘set of features’ refers to a collection of variables that represent the relevant characteristics of each cardholder's transactional behaviors.

At operation 406, the method 400 includes generating, by the server system 200, an opt-out feature for each cardholder based, at least in part, on a historical transaction dataset 218. Herein, the opt-out feature indicates whether an individual cardholder has requested to cancel ongoing recurrent payments with the merchant 106(1).

At operation 408, the method 400 includes generating, by a Machine Learning (ML) model 220 associated with the server system 200, an attrition score for each cardholder of the subset of cardholders based, at least in part, on the corresponding set of features, and the corresponding opt-out feature of each cardholder. Herein, the attrition score indicates a probability of each cardholder refraining from engaging in future transactions with the merchant 106(1).

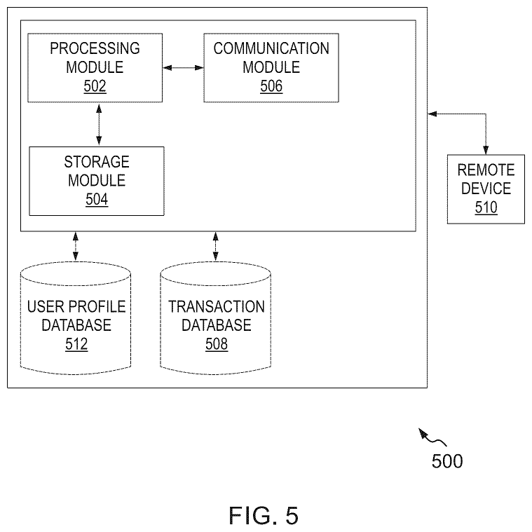

FIG. 5 illustrates a simplified block diagram of the acquirer server 500, in accordance with an embodiment of the present disclosure. The acquirer server 500 is an example of the acquirer server 108(1) of FIG. 1. The acquirer server 500 is associated with an acquirer bank/acquirer (not shown), in which a merchant 106(1) may have an account, which provides a payment card. The acquirer server 500 includes a processing module 502 operatively coupled to a storage module 504 and a communication module 506. The components of the acquirer server 500 provided herein may not be exhaustive, and the acquirer server 500 may include more or fewer components than those depicted in FIG. 5. Further, two or more components may be embodied in one single component, and/or one component may be configured using multiple sub-components to achieve the desired functionalities. Some components of the acquirer server 500 may be configured using hardware elements, software elements, firmware elements, and/or a combination thereof.

The storage module 504 is configured to store machine-executable instructions to be accessed by the processing module 502. Additionally, the storage module 504 stores information related to the contact information of the merchant 106(1), bank account number, availability of funds in the account, payment card details, transaction details, and/or the like. Further, the storage module 504 is configured to store payment transactions.

In one embodiment, the acquirer server 500 is configured to store profile data (e.g., an account balance, a credit line, details of the plurality of merchants 106, account identification information, and a payment card number) in a transaction database 508. The details of the plurality of merchants 106 may include, but are not limited to, name, age, gender, physical attributes, location, registered contact number, family information, alternate contact number, registered e-mail address, etc.

The processing module 502 is configured to communicate with one or more remote devices, such as a remote device 510, using the communication module 506 over a network such as the network 116 of FIG. 1. The examples of the remote device 510 include the server system 200, the payment server 114, the issuer server 110(1), or other computing systems of the acquirer server 500, and the like. The communication module 506 is capable of facilitating such operative communication with the remote devices and cloud servers using Application Program Interface (API) calls. The communication module 506 is configured to receive a payment transaction request performed by the plurality of cardholders 104 via the network 116. The processing module 502 receives payment card information, a payment transaction amount, cardholder information, and merchant information from the remote device 510 (i.e., the payment server 114). The acquirer server 500 includes a user profile database 512 and the transaction database 508 for storing transaction data. The user profile database 512 may include information of merchants 106. The transaction data may include but is not limited to, transaction attributes, such as transaction amount, source of funds such as bank or credit cards, transaction channel used for loading funds such as POS terminal or ATM machine, transaction velocity features, such as count and transaction amount sent in the past x days to a particular user, transaction location information, external data sources, and other internal data to evaluate each transaction.

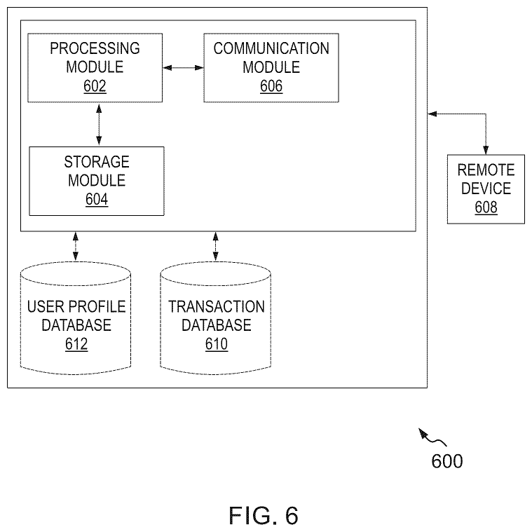

FIG. 6 illustrates a simplified block diagram of an issuer server 600, in accordance with an embodiment of the present disclosure. The issuer server 600 is an example of the issuer server 110(1) of FIG. 1. The issuer server 600 is associated with an issuer bank/issuer, in which an account holder (e.g., the plurality of cardholders 104(1)-104(N)) may have an account which provides a payment card. The issuer server 600 includes a processing module 602 operatively coupled to a storage module 604 and a communication module 606. The components of the issuer server 600 provided herein may not be exhaustive, and the issuer server 600 may include more or fewer components than those depicted in FIG. 6. Further, two or more components may be embodied in one single component, and/or one component may be configured using multiple sub-components to achieve the desired functionalities. Some components of the issuer server 600 may be configured using hardware elements, software elements, firmware elements, and/or a combination thereof.

The storage module 604 is configured to store machine-executable instructions to be accessed by the processing module 602. Additionally, the storage module 604 stores information related to the contact information of the cardholders (e.g., the plurality of cardholders 104(1)-104(N)), a bank account number, availability of funds in the account, payment card details, transaction details, payment account details, and/or the like. Further, the storage module 604 is configured to store payment transactions.

In one embodiment, the issuer server 600 is configured to store profile data (e.g., an account balance, a credit line, details of the cardholders 104, account identification information, payment card number, etc.) in the database 204. The details of the cardholders 104 may include, but are not limited to, name, age, gender, physical attributes, location, registered contact number, family information, alternate contact number, registered e-mail address, or the like of the cardholders 104, etc.

The processing module 602 is configured to communicate with one or more remote devices, such as a remote device 608, using the communication module 606 over a network such as the network 116 of FIG. 1. Examples of the remote device 608 include the server system 200, the payment server 114, the acquirer server 108(1) or other computing systems of the issuer server 600. The communication module 606 is capable of facilitating such operative communication with the remote devices and cloud servers using API calls. The communication module 606 is configured to receive a payment transaction request performed by an account holder (e.g., the cardholder 104(1)) via the network 116. The processing module 602 receives payment card information, a payment transaction amount, cardholder information, and merchant information from the remote device 608 (e.g., the payment server 114). The issuer server 600 includes a transaction database 610 for storing transaction data. The transaction data may include, but is not limited to, transaction attributes, such as transaction amount, source of funds such as bank or credit cards, transaction channel used for loading funds such as the POS terminal or ATM machine, transaction velocity features such as count and transaction amount sent in the past x days to a particular account holder, transaction location information, external data sources, and other internal data to evaluate each transaction. The issuer server 600 includes a user profile database 612 storing user profiles associated with the plurality of account holders.

The user profile data may include an account balance, a credit line, details of the account holders, account identification information, payment card number, or the like. The details of the account holders (e.g., the plurality of cardholders 104(1)-104(N)) may include, but are not limited to, name, age, gender, physical attributes, location, registered contact number, family information, alternate contact number, registered e-mail address, or the like of the plurality of cardholders 104.

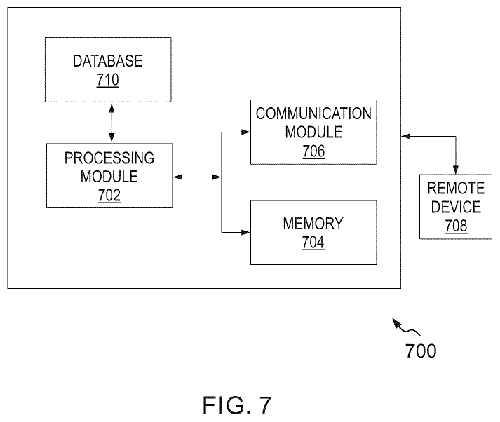

FIG. 7 illustrates a simplified block diagram of the payment server 700, in accordance with an embodiment of the present disclosure. The payment server 700 is an example of the payment server 114 of FIG. 1. The payment server 700 and the server system 200 may use the payment network 112 as a payment interchange network.

The payment server 700 includes a processing module 702 configured to extract programming instructions from a memory 704 to provide various features of the present disclosure. The components of the payment server 700 provided herein may not be exhaustive, and the payment server 700 may include more or fewer components than that depicted in FIG. 7. Further, two or more components may be embodied in one single component and/or one component may be configured using multiple sub-components to achieve the desired functionalities. Some components of the payment server 700 may be configured using hardware elements, software elements, firmware elements, and/or a combination thereof.

Via a communication module 706, the processing module 702 receives a request from a remote device 708, such as the issuer server 110(1), the acquirer server 108(1), or the server system 102. The request may be a request for conducting the payment transaction. The communication may be achieved through API calls without loss of generality. The payment server 700 includes a database 710. The database 710 also includes transaction processing data such as issuer ID, country code, acquirer ID, and Merchant Identifier (MID), among others.

When the payment server 700 receives a payment transaction request from the acquirer server 108(1) or a payment terminal (e.g., IoT device), the payment server 700 may route the payment transaction request to an issuer server (e.g., the issuer server 110(1)). The database 710 stores transaction identifiers for identifying transaction details, such as transaction amount, IoT device details, acquirer account information, transaction records, merchant account information, and the like.

In one example embodiment, the acquirer server 108(1) is configured to send an authorization request message to the payment server 700. The authorization request message includes, but is not limited to, the payment transaction request.

The processing module 702 further sends the payment transaction request to the issuer server 110(1) for facilitating the payment transactions from the remote device 708. The processing module 702 is further configured to notify the remote device 708 of the transaction status in the form of an authorization response message via the communication module 706. The authorization response message includes, but is not limited to, a payment transaction response received from the issuer server 110(1). Alternatively, in one embodiment, the processing module 702 is configured to send an authorization response message for declining the payment transaction request via the communication module 706 to the acquirer server 108(1). In one embodiment, the processing module 702 executes similar operations performed by the server system 200, however, for the sake of brevity, these operations are not explained herein.

The disclosed method 400 with reference to FIG. 4, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium. Herein, the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media.

Examples of non-transitory computer-readable media include magnetic storage media (such as floppy disks, magnetic tapes, hard disk drives, etc.), optical magnetic storage media (e.g., magneto-optical disks), Compact Disc Read-Only Memory (CD-ROM), Compact Disc Recordable (CD-R), compact disc rewritable (CD-R/W), Digital Versatile Disc (DVD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more nonvolatile memory devices, and/or a combination of one or more volatile memory devices and nonvolatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method comprising:
accessing, by a server system, information related to a subset of cardholders from a database associated with the server system;
generating, by the server system, a set of features for each cardholder in the subset of cardholders based, at least in part, on one or more transaction attributes associated with each transaction performed by each cardholder from the subset of cardholders;
generating, by the server system, an opt-out feature for each cardholder based, at least in part, on a historical transaction dataset, wherein the opt-out feature indicates whether an individual cardholder has requested to cancel ongoing recurrent payments with the merchant; and
generating, by a Machine Learning (ML) model associated with the server system, an attrition score for each cardholder of the subset of cardholders based, at least in part, on the corresponding set of features, and the corresponding opt-out feature of each cardholder, wherein the attrition score indicates a probability of each cardholder refraining from engaging in future transactions with the merchant.

2. The computer-implemented method as claimed in claim 1, further comprises:
accessing, by a server system, the historical transaction dataset from the database associated with the server system, wherein the historical transaction dataset comprises one or more transaction attributes related to a set of transactions performed between a set of cardholders and the merchant;
identifying, by the server system, the subset of cardholders from the set of cardholders based, at least in part, on predefined criteria, wherein the subset of cardholders comprises at least one cardholder transacting regularly with the merchant; and
storing, by the server system, the information related to the subset of cardholders in the database.

3. The computer-implemented method as claimed in claim 1, further comprises:
receiving, by the server system, one or more recurrent transaction cancellation requests associated with the merchant from the one or more cardholders; and
storing, by the server system, the one or more recurrent transaction cancellation requests in the historical transaction dataset.

4. The computer-implemented method as claimed in claim 1, wherein generating the attrition score comprises:
generating, by the server system, an alternate merchant feature for each cardholder based, at least in part, on the one or more transaction attributes associated with each transaction performed by each cardholder, wherein the alternate merchant feature indicates whether an individual cardholder performs at least one transaction at another merchant; and
computing, by the ML model, the attrition score based, at least in part, on the set of features, the opt-out feature, and the alternative merchant feature.

5. The computer-implemented method as claimed in claim 1, wherein generating the attrition score comprises:
generating by the server system, a cardholder inactivity feature for each cardholder based, at least in part, on the one or more transaction attributes associated with each transaction performed by each cardholder, wherein the cardholder inactivity feature indicates whether an individual cardholder has not performed a transaction for a predefined time period; and
computing, by the ML model, the attrition score based, at least in part, on the set of features, the opt-out feature, and the cardholder inactivity feature.

6. The computer-implemented method as claimed in claim 1, further comprises:
receiving, by the server system, a prediction request for an individual cardholder from the merchant; and
generating, by the ML model, a prediction associated with the individual cardholder based, at least in part, on the attrition score associated with the individual cardholder, the prediction indicating a probability of the individual cardholder refraining from engaging in future transactions with the merchant.

7. The computer-implemented method as claimed in claim 1, further comprises:
transmitting, by the server system, the attrition score for each cardholder of the subset of cardholders to the merchant.

8. The computer-implemented method as claimed in claim 1, further comprises:
generating, by the server system, a visualization for representing the attrition score on a display associated with an electronic device of the merchant.

9. The computer-implemented method as claimed in claim 1, further comprising:
receiving, by the server system, a training dataset comprising a set of data samples, each data sample comprising a set of training features and an associated target value;
initializing, by the server system, an ensemble of decision trees present in the ML model, wherein each decision tree is associated with a weight; and
training, by the server system, each tree in a predefined sequence based, at least in part, on performing a set of operations iteratively till the ML model achieves predefined criteria, the set of operations comprising:
generating, by a decision tree, a training prediction based, at least in part, on the set of training features;
computing, by the ML model, a prediction residual based, at least in part, on comparing the training prediction with the associated target value;
assigning a weight to each data sample based, at least in part, on the prediction residual;
generating, by the ML model, another decision tree based, at least in part, on each weighted data sample to minimize a loss function; and
optimizing the weight associated with the another decision tree based, at least in part, on an overall prediction error generated by the ensemble of trees.

10. The computer-implemented method as claimed in claim 1, wherein the server system is a payment server associated with a payment network.

11. A server system, comprising:
a communication interface;
a memory comprising executable instructions; and
a processor communicably coupled to the communication interface and the memory, the processor configured to cause the server system to at least:
access information related to a subset of cardholders from a database associated with the server system;
generate a set of features for each cardholder in the subset of cardholders based, at least in part, on one or more transaction attributes associated with each transaction performed by each cardholder from the subset of cardholders;
generate, by the server system, an opt-out feature for each cardholder based, at least in part, on a historical transaction dataset, wherein the opt-out feature indicates whether an individual cardholder has requested to cancel ongoing recurrent payments with the merchant; and
generate by a Machine Learning (ML) model associated with the server system, an attrition score for each cardholder of the subset of cardholders based, at least in part, on the corresponding set of features, and the corresponding opt-out feature of each cardholder, wherein the attrition score indicates a probability of each cardholder refraining from engaging in future transactions with the merchant.

12. The server system as claimed in claim 11, wherein the server system is further caused, at least in part, to:
access the historical transaction dataset from the database associated with the server system, wherein the historical transaction dataset comprises one or more transaction attributes related to a set of transactions performed between a set of cardholders and the merchant;
identify the subset of cardholders from the set of cardholders based, at least in part, on predefined criteria, wherein the subset of cardholders comprises at least one cardholder transacting regularly with the merchant from the set of merchants; and
store the information related to the subset of cardholders in the database.

13. The server system as claimed in claim 11, wherein the server system is further caused, at least in part, to:
receive the one or more recurrent transaction cancellation requests associated with the merchant from the one or more cardholders; and
store the one or more recurrent transaction cancellation requests in the historical transaction dataset.

14. The server system as claimed in claim 11, to generate the attrition score the server system is caused, at least in part, to:
generate an alternate merchant feature for each cardholder based, at least in part, on the one or more transaction attributes associated with each transaction performed by each cardholder, wherein the alternate merchant feature indicates whether an individual cardholder performs at least one transaction at another merchant; and
compute by the ML model, the attrition score based, at least in part, on the set of features, the opt-out feature, and the alternative merchant feature.

15. The server system as claimed in claim 11, to generate the attrition score the server system is caused, at least in part, to:
generate a cardholder inactivity feature for each cardholder based, at least in part, on the one or more transaction attributes associated with each transaction performed by each cardholder, wherein the cardholder inactivity feature indicates whether an individual cardholder has not performed a transaction for a predefined time period; and
compute by the ML model, the attrition score based, at least in part on, the set of features, the opt-out feature, and the cardholder inactivity feature.

16. The server system as claimed in claim 11, wherein the server system is further caused, at least in part, to:
receive a prediction request for an individual cardholder from the merchant; and
generate, by the ML model, a prediction associated with the individual cardholder based, at least in part, on the attrition score associated with the individual cardholder, the prediction indicating a probability of the individual cardholder refraining from engaging in future transactions with the merchant.

17. The server system as claimed in claim 11, wherein the server system is further caused, at least in part, to:
transmit the attrition score for each cardholder of the subset of cardholders to the merchant.

18. The server system as claimed in claim 11, wherein the server system is further caused, at least in part, to:
generate a visualization for representing the attrition score on a display associated with an electronic device of the merchant.

19. The server system as claimed in claim 11, wherein the server system is further caused, at least in part, to:
receive a training dataset comprising a set of data samples, each data sample comprising a set of training features and an associated target value;
initialize an ensemble of decision trees present in the ML model, wherein each decision tree is associated with a weight; and
train each tree in a predefined sequence based, at least in part, on performing a set of operations iteratively till the ML model achieves predefined criteria, the set of operations comprising:
generate, by a decision tree, a training prediction based, at least in part, on the set of training features;
compute, by the ML model, a prediction residual based, at least in part, on comparing the training prediction with the associated target value;
assign, a weight to each data sample based, at least in part, on the prediction residual;
generate, by the ML model, another decision tree based, at least in part, on each weighted data sample to minimize a loss function; and
optimize, the weight associated with the another decision tree based, at least in part, on an overall prediction error generated by the ensemble of trees.

20. A non-transitory computer-readable storage medium comprising computer-executable instructions that, when executed by at least a processor of a server system, cause the server system to perform a method comprising:
accessing information related to a subset of cardholders from a database associated with the server system;
generating a set of features for each cardholder in the subset of cardholders based, at least in part, on one or more transaction attributes associated with each transaction performed by each cardholder from the subset of cardholders;
identifying one or more recurrent transaction cancellation requests associated with a merchant from one or more cardholders from the subset of cardholders based, at least in part, on a historical transaction dataset;
generating an opt-out feature for each cardholder based, at least in part, on the one or more recurrent transaction cancellation requests, wherein the opt-out feature indicates that an individual cardholder has requested to cancel ongoing recurrent payments with the merchant; and
generating, by a Machine Learning (ML) model associated with the server system, an attrition score for each cardholder of the subset of cardholders based, at least in part, on the corresponding set of features, and the corresponding opt-out feature of each cardholder, wherein the attrition score indicates a probability of each cardholder refrains from transacting at the merchant.
